(19) United States
(12) Patent Application Publication
(10) Pub. No.: US 2016/0050861 A1
(43) Pub. Date: Feb. 25, 2016

(54) SELF-PRIMING WICK TO WICK LIQUID TRANSFER SYSTEM

(71) Applicant: Jeffrey Scott Abbott, Seminole, FL (US)

(72) Inventor: Jeffrey Scott Abbott, Seminole, FL (US)

(21) Appl. No.: 14/825,588

(22) Filed: Aug. 13, 2015

Related U.S. Application Data
(60) Provisional application No. 62/040,030, filed on Aug. 21, 2014.

(51) Int. Cl. A01G 27/04

(52) U.S. Cl. CPC A01G 27/04

(57) ABSTRACT

A self-priming wick to wick liquid transfer system. The system is preferable for watering plants. The functionality is very simple and user friendly. The system can be used in nearly every way a non self-watering planter is used, both indoors and outdoors, giving it a versatility and usability that other self-watering systems or devices do not have.

### CROSS-REFERENCE TO RELATED APPLICATION

This application claims the benefit of priority of U.S. provisional application No. 62/040,030, filed Aug. 21, 2014, the contents of which are herein incorporated by reference.

### BACKGROUND OF THE INVENTION

The present invention relates to watering devices and, more particularly, to watering devices for plants, flower pots, window boxes, planters, and the like.

Conventional systems or devices that use wicks for watering plants in planters do not allow the planter to be separated from the water source into which the wick must extend to wick water into the planter. Similarly, conventional wick watering systems require the wick to be primed in order to transfer water in the first instance, or re priming should the wick dry out.

Other devices or systems for watering plants require extra work to set up, use or maintain. Many are over complicated, which discourages use and can create problems or they are integrated which can limit use. Some will only work with a planter that is specifically designed for the system.

The ability to move, rotate, repot and in general work with the planter in the same manner as most non self-watering planters is prohibitive in existing systems with a unitary wick.

Other systems or devices can have any number of issues with complexity, integration and or they are difficult to separate, to clean, to prime, to re prime and to determine how much water is available.

As can be seen, there is a need for a self-priming watering device that permits the planters to be readily removed from the reservoir so that the plant may be cared for.

### SUMMARY OF THE INVENTION

In one aspect of the present invention, dual wick liquid transfer system, having a reservoir wick with a first end disposed external to a reservoir and a second end disposed within the reservoir. A receiving wick having a first end selectively positioned in abutment with the first end of the reservoir wick, wherein a liquid contained within the reservoir is communicated from the reservoir wick to a second end of the receiving wick when the reservoir wick and the receiving wick are in abutment with each other. The dual wick liquid transfer system may also include a reservoir wick pad defined at the second end of the reservoir wick and a receiving wick pad defined at the first end of the receiving wick. The reservoir wick pads are selectively positioned in abutment with each other to better communicate a liquid between the first and second wick.

In aspects of the invention, the said first wick and said second wick are formed from a microfiber material.

In some aspects of the invention a container is provided, wherein the second end of the receiving wick is received within the container and the first end of the receiving wick is positioned external to the container. The container may selectively be placed on the reservoir to position the reservoir wick in abutment with the receiving wick. In some instances of the invention, the container may have an opening defined in a bottom surface of the container, and the first end of said receiving wick is disposed through said opening and into said container. In certain preferred embodiments, the container is a planter.

In other aspects of the invention an aperture is defined in a top surface of the reservoir and the first end of the reservoir wick is received through the aperture. The top surface of said reservoir may comprise a lid and the reservoir further may include a fill port communicating a source of liquid for containment in the reservoir.

An alternative embodiment of the liquid transfer system, may include a contained liquid source, a first wick having a first end disposed external to the contained liquid source and a second end in communication with the contained liquid source. A second wick, has a first end that may be selectively positioned in abutment with the first end of the first wick and a second end that is disposed within a container. A liquid contained within the contained liquid source is communicated from the first wick to the second wick when the first wick and second wick are in abutment with each other. The first wick and said second wick are most preferably formed with a microfiber material.

In preferred aspects of the invention a growing medium is contained within container, the second wick communicates the liquid to said growing medium. The container may comprise an opening defined in a bottom surface of in container, and the second wick is received through the opening.

In yet another aspect of the invention, the contained liquid source includes a cap with an aperture defined therein and the first wick is received through the aperture. The contained liquid source may further comprise a reservoir.
These and other features, aspects and advantages of the present invention will become better understood with reference to the following drawings, description and claims.

### BRIEF DESCRIPTION OF THE DRAWINGS

FIG. 1 is a front perspective view of an embodiment of the invention.

FIG. 2 is a front exploded view of an embodiment of the invention.

FIG. 3 is another exploded perspective view of an embodiment of the invention.

FIG. 4 is a cross-sectional view taken on line 4-4 of FIG. 1.

FIG. 5 is a front perspective view of an alternative embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a self-watering system for plants. The system provides for a direct wick to wick transfer of water from a water source, such as a reservoir, to a growing medium, such as soil, contained within a planter, flower pot, window box, or the like.

The system of the present invention provides a self-watering system that can work with the majority of existing planters available today in retail stores and/or a planter that was designed specifically to work with the watering system. The watering system can work without the use of mechanical or electrical components. The water supply of the present invention may be separate from the planter and be able to supply water to a planter without any complicated requirements for attaching or detaching it to the planter.

The ability to move, rotate, repot and in general work with the planter in the same manner as most non self-watering planters must be maintained. The water system contemplated by embodiments of the present invention is capable of supplying water to a planter over extended periods of time automatically and it must not transfer a larger amount of water than the amount the soil in the planter can absorb at any time.

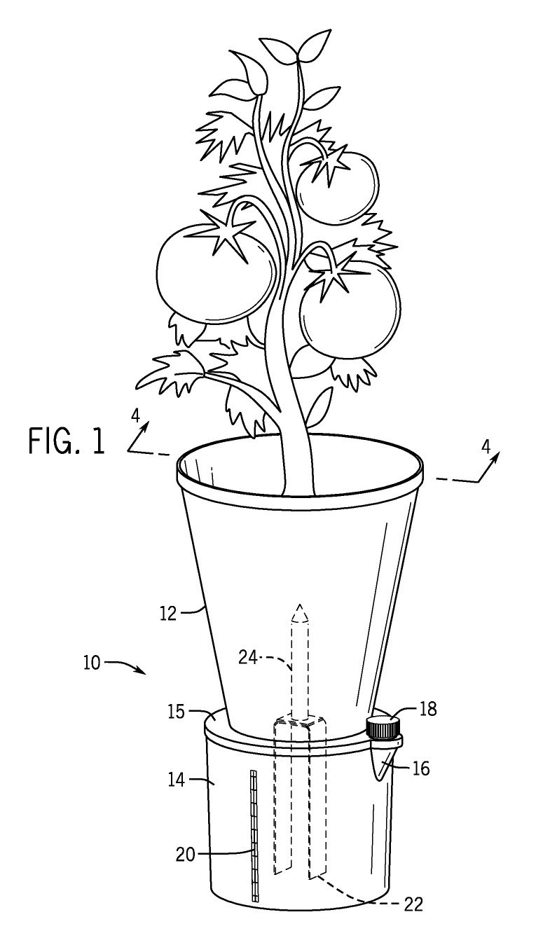

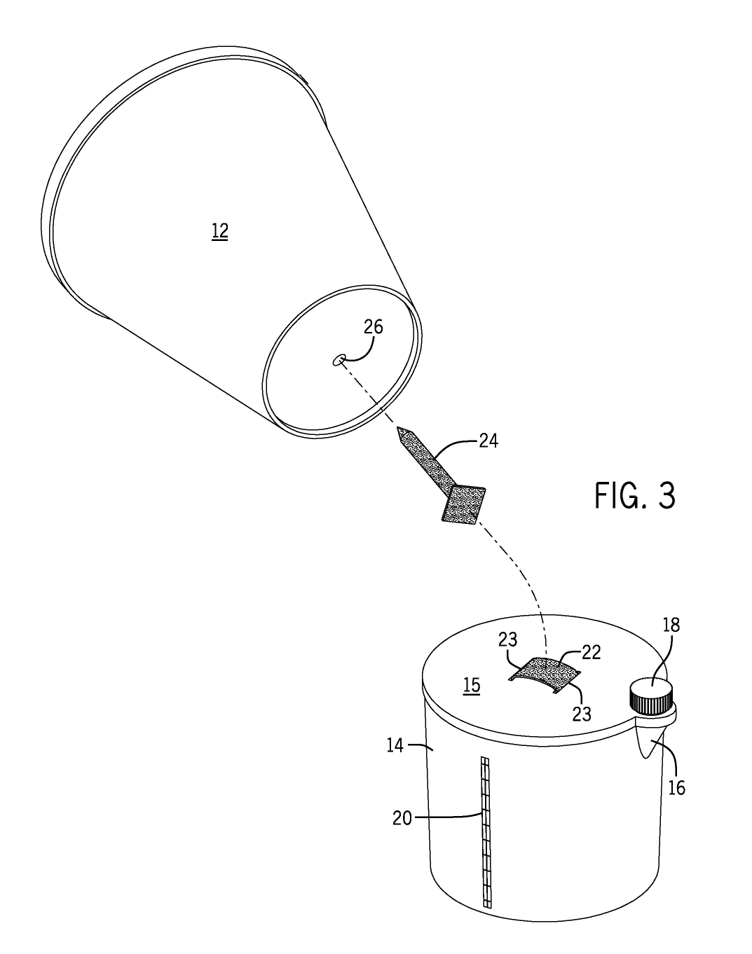

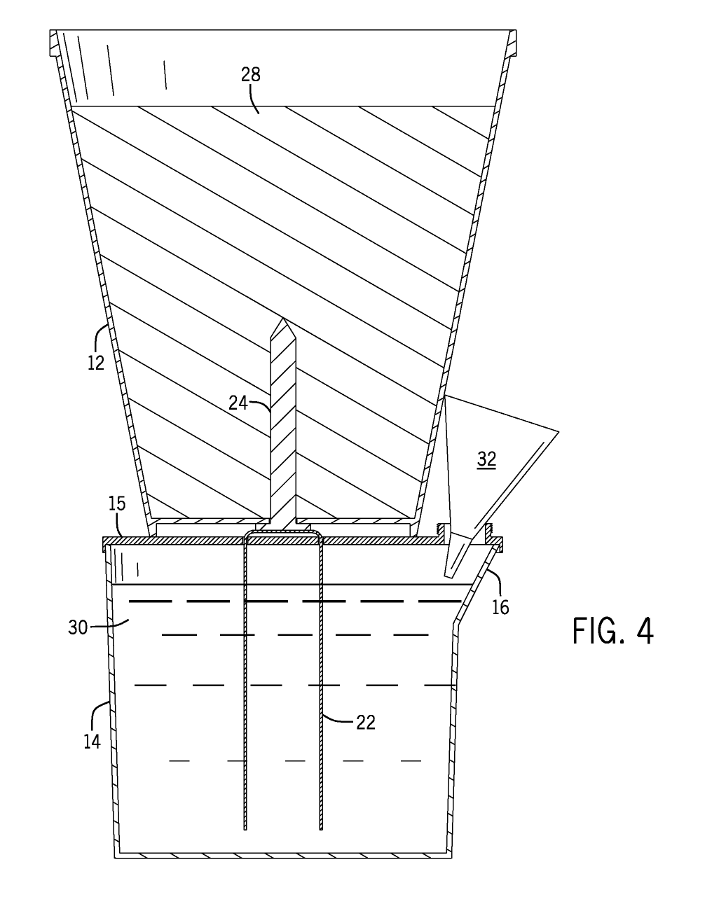

As seen in reference to FIGS. 1-4, an embodiment of a watering device 10 of the present invention provides water 30 to a container 12, such as planter 12, containing a soil in which to grow plants, such as the tomatoes shown in the drawing. Planter 12, may include virtually any shape and size flower pot, a window box, or the like. The watering device 10 includes a reservoir 14, for containing a source of liquid 30, such as a volume of water contained therein. Preferably, the reservoir 14 will include a top surface, a lid, or a cap 15 to prevent the accumulation of dirt and debris in the reservoir 14, to prevent the evaporation or escape of water 30 from the water source, as well as preventing the undesirable infiltration of insects into the water 30 contained within reservoir 14, where they may find a breeding ground, such as mosquitoes.

As will be appreciated, the reservoir 14 can be made from a number of different materials such as plastic, metal, ceramic, or wood, that are suitable for retaining liquids. The reservoir 14 can be made into different shapes such as square, rectangular, rounded, oval etc. The shape has to be capable of holding liquids. The lid 15 can be constructed of a similar material as the reservoir 14.

The lid 15 will have an aperture 23 for a wick to be inserted. This aperture 23 can be placed anywhere on the lid 15, but it is preferred that it is centered on the lid 15. Preferably, the lid 15 has a second opening 16, or fill port, this opening is for adding liquids, and it is made near the outer edge of the lid 15 with the intention of it not being covered by a planter 12 when a planter 12 is placed on top of the lid 15, so the planter 12 will not have to be removed to fill the reservoir 14. This opening should have a cap 18 that can be opened and closed. The cap 18 can be made of a similar material as those used to make the reservoir 14 and lid 15.

The reservoir 14 may further include a spout, or fill port 16 for replenishing the water supply held by the reservoir 13. More, preferably, the fill port 16 will include a cap 18, to seal the reservoir and prevent spillage, should the user desire to move the reservoir 14, and or the reservoir 14 and planter 12. As will be appreciated, a funnel 32 may be utilized to fill and replenish the reservoir 14 with water 30.

As an additional aspect of the invention, the reservoir 14 may further include a fluid level gauge 20, to provide the user at least a visual indication of the level of water contained or remaining in the reservoir 14 as the water 30 is depleted. The water level indicator 20 is not mandatory but it does simplify determining how much water 30 is available and how much to add. The indicator 30 could be a number of different configurations such as a gauge on the cap 15 or an internal float that turns on an LED light when the water level is low.

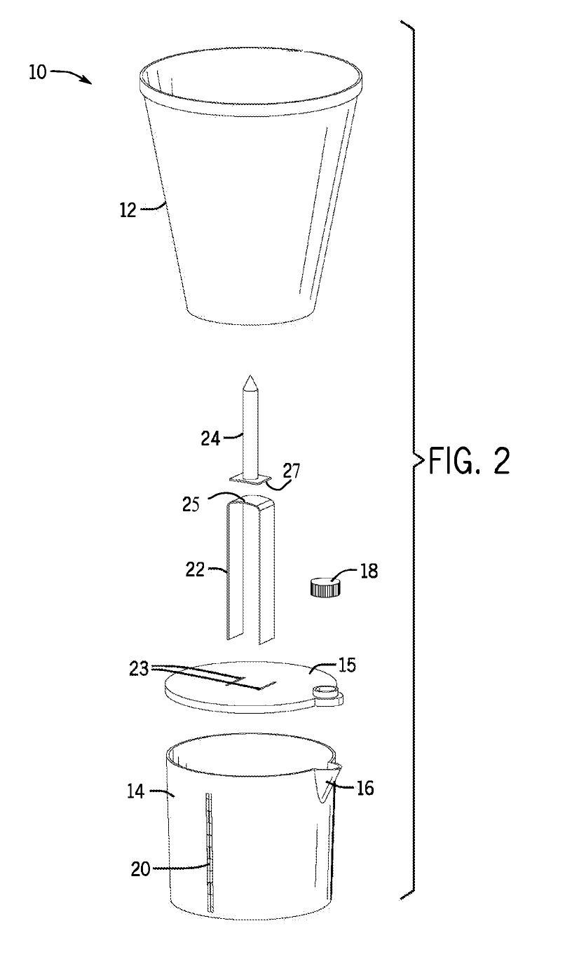

Embodiments of the invention will also include a first wick element 22 having a first end suspended between a top of the reservoir 14 and a second end of the first wick element 22 disposed towards the bottom of the reservoir 14. The first wick element 22, may also be referred to herein as the reservoir wick 22. Preferably, the reservoir wick 22 will extend through an opening 23 in the reservoir lid 15. The opening 23, may be a slotted arrangement, such as shown in reference to FIG. 2. The reservoir wick 22 is positioned such that it will be in abutment with a second wick 24, also referred to herein as a planter wick 24 or a receiving wick 24, that is preferably received through an aperture 26, such as a drain hole 26, defined in a bottom surface of the planter 12.

As seen in reference to FIG. 2, the reservoir wick 22 has a substantially flat profile, however, the shape of the reservoir wick 22 is not critical to the functioning of the watering device 10. The reservoir wick 22 should be such that it provides a suitable surface area to the full depth of the water contained in the reservoir 14. Similarly, while the planter wick 24 is depicted with a spike shape, the overall shape of the planter wick 24 should provide a suitable surface area to contact the soil contained within the planter 12. As best seen in reference to FIG. 2, the reservoir wick 22 should also present a reservoir wick contact surface 25 for abutment with a corresponding wick planter wick contact surface 27.

According to a preferred aspect of the invention, the reservoir wick 22 and the planter wick 24 are comprised of a microfiber material. Use of the microfiber material provides a preferred wicking medium that permits self-priming of the reservoir wick 22 and planter wick 24. That is, water absorbed by the reservoir wick 22 is readily transferred, via wicking action to the planter wick 24.

The dual wick 22, 24 of the watering device 10 makes it useable in nearly every way non self-watering planters have been used throughout history with the benefit of a water supply that can last for extended periods of time without out need for attention. Unlike other systems or devices that use wicks for watering plants in planters, the wicks 22, 24 of the present invention are self-priming and easily separate from one another, which eliminates any encumbrance to separating the planter 12 from the reservoir 14. Moreover, there are no priming or re priming requirements should the wick dry out.

As stated, the wicks 22, 24 are made from a split fiber microfiber cloth. This cloth is made by numerous manufacturers. The material is cut to the lengths needed and shaped to insert one into the planter 12 and one into the reservoir 14 and to form a pad 25, 27 on the exteriors of the planter 12 and reservoir 14. The planter 12 can be manufactured specifically to fit the reservoir 14 or it can be almost any planter 12 available that will fit on top of the reservoir 14. An opening 26 in the bottom of the planter 12 is provided for the wick 24 to be inserted, this opening 26 can be a preexisting drain hole or it can be drilled into the planter 14.

The wick pad 25 on the reservoir and the wick pad 27 on the planter 14 must make contact for the liquids 30 to transfer, so the opening 23 in the reservoir lid 15 and the opening 26 in the planter 12 that is intended for the wicks to be inserted should be located so as to insure the two wicks 22, 24 make contact when the planter 14 is placed on the reservoir lid 15.

The dual microfiber wicks 22, 24 are the most important and a necessary element. The microfiber material is what makes it possible for the capillary action to take place without pre-wetting and ensures the water 30 will transfer out of the reservoir 14 and into the planter 12 when the wicks 22, 24 are placed in contact with each other. Having a wick to wick system is the key to separating the planter 12 from the reservoir 14 without any encumbrances.

The wicking material could be wrapped around and attached to a semi-rigid piece of plastic or other material to help with inserting the wicks 22, 24 into the planter 12 and reservoir 14; this could also serve as an aid to locking them in place.

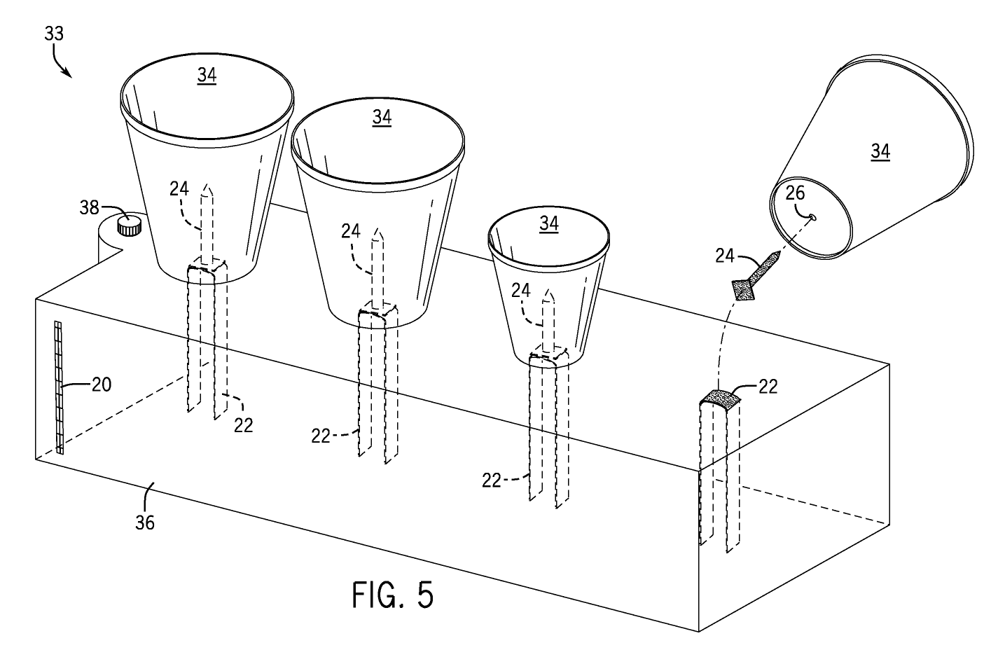

As seen in reference to FIG. 5, a reservoir 36 may optionally be provided with a plurality of reservoir wicks 22 for mating abutment with one or more planter wicks 24. The planter wicks 24 may be disposed in each of a plurality of planters 34. Alternatively, a large planter, with a plurality of planter wicks 24 positioned in abutment with reservoir wicks 22 is also contemplated by the present invention.

Having thus described an embodiment of the watering device 10, a description of the use of the watering device 10 is presented. The planter 12 is placed on top of the reservoir 14 and reservoir lid 15. In so placing the planter 12, the planter wick 24 is placed in contact with the reservoir wick 22 inserted into the reservoir 14. There are no other attachment requirements. By this arrangement, the user may simple pick up the planter 12 to detach it from the reservoir. The user may then reposition the planter 12 to a suitable location to care for the plant, such as transplanting to a larger pot, or any number of other tasks necessary to care for a particular plant species.

In use, the water 30 will transfer on contact with the reservoir wick 22, and by capillary action will convey the water 30 from the self-priming reservoir wick 22 to the self-priming planter wick 24 and, thereby into the soil or growing medium contained within the planter 12. The use of two separate self-priming microfiber wicks eliminates the issues with conventional wicks, such as, priming the wicks and the inability to separate the planter 12 from the reservoir 14 without removing the wick from one or both.

Once an area is selected for the placement of the watering device 10, the user would place the reservoir in the selected area. Where applicable, the lid 15 for the reservoir 14 is installed on top of the reservoir 14. The reservoir wick 22 would then be inserted into the opening 23 for the reservoir wick 22. The planter wick 24 would then be inserted into the selected planter 12. The planter 12 can be filled with soil 28, or growing medium, and seeds or plants at this time, or prior to inserting the planter wick 24. The planter 12 would then be placed on top of the reservoir lid 15 while making sure the wick pad 25 on the planter 12 and the wick pad 27 on the reservoir 14 are in contact with one another. The user would fill the reservoir 14 with water 30 until it is substantially full. Upon contact with the water 30 or liquid nutrients, the reservoir wick 22 will begin absorbing the water 30 and through capillary action transfer the water 30 or nutrients from the reservoir wick to the to the planter wick 24, which is inserted into the planter 12. The wicks 22, 24 will transfer a constant supply of water 30 and or nutrients into the soil 28 or growing medium but only the amount of liquid the soil 28 or growing medium 28 can absorb. This prevents over and under watering of the plants, both of which can be detrimental to the plant(s) growing in the planter 12. This method provides the planter 12 with a consistent supply of water 30 for extended periods of time.

Depending on a few factors such as the water requirements of the plants in the planter 12, the amount of moisture lost due to evaporation and the capacity of the reservoir 12, the reservoir 12 could potentially last for months before it needs to be refilled. The water level indicator 20 is used to monitor the water level in the reservoir. By never having to pour water 30 directly into the planter 12, there will not be any of the problems associated with doing so, such as; washing out the soil 28 or growing medium 28 from the top or bottom, washing out the nutrients, overfilling or under watering.

There are no restrictions on moving or repositioning the planter 12. It can be turned around, taken away from the reservoir for trimming or transplanting, and then returned to the reservoir 14 without having to disconnect or reconnect any connections. Thu user simply makes sure the wick pads 25, 27 make contact when the planter 14 is replaced on the reservoir 12. If the user is transplanting plants, the user may use a new wick 24 or remove the planter wick 24 from the previous planter 12 and insert it into the new planter before placing the new planter 12 on the reservoir 14.

Additionally, the potential for use on a large scale nursery or farm to reduce water waste usage is huge. The water reservoir 14 could be replenished with a piping system that could be filled at one access point. All the plants could be watered at once, from the roots, eliminating water lost by conventional top down means of watering.

The dual wick configuration of the present invention may be are used in many different applications and different industries, in most cases it is a single wick that must be wetted prior to use. The dual element self-priming wick of the present invention eliminates the wetting step of conventional wicks and by separating the wick into two wicks changes how wicks will be used in the future. A conventional single wick integrates or unnecessarily ties the reservoir and the object to which the liquid in the reservoir is intended to be transferred. According to the present invention, a set of separable wick elements will eliminate the need for such integration and permits selective separation of the reservoir from the object to which the liquid is conveyed via the wicks, allowing for ease of use and access.

It should be understood, of course, that the foregoing relates to exemplary embodiments of the invention and that modifications may be made without departing from the spirit and scope of the invention as set forth in the following claims.

What is claimed is:

1. A dual wick liquid transfer system, comprising:
a reservoir wick having a first end disposed external to a reservoir and a second end disposed within said reservoir;
a receiving wick having a first end selectively positioned in abutment with said first end of said reservoir wick, wherein a liquid contained within said reservoir is communicated from said reservoir wick to a second end of said receiving wick when said reservoir wick and said receiving wick are in abutment with each other.

2. The dual wick liquid transfer system of claim 1, further comprising:
a reservoir wick pad defined at said first end of said reservoir wick;
a receiving wick pad defined at said first end of said receiving wick, wherein said reservoir wick pad is selectively positioned in abutment with said receiving wick pad.

3. The dual wick liquid transfer system of claim 1, further comprising:
said reservoir wick and said receiving wick are formed from a microfiber material.

4. The dual wick liquid transfer system of claim 1, further comprising:
a container, wherein said second end of receiving wick is received within said container and said first end of said receiving wick is positioned external said container, said container selectively placed on said reservoir to position said reservoir wick in abutment with said receiving wick.

5. The dual wick liquid transfer system of claim 4, wherein said container comprises an opening defined in a bottom surface of said container, and said second end of said receiving wick is disposed through said opening and into said container.

6. The dual wick liquid transfer system of claim 4, further comprising:
an aperture defined in a top surface of said reservoir and first end of said reservoir wick is received through the aperture.

7. The dual wick liquid transfer system of claim 6, wherein said top surface of said reservoir comprises a lid.

8. The dual wick liquid transfer system of claim 6, wherein said reservoir further comprises a fill port communicating a source of said liquid for containment in said reservoir.

9. The dual wick liquid transfer system of claim 4, wherein said container comprises a planter.

10. A liquid transfer system, comprising:
a contained liquid source,
a first wick having a first end disposed external to said contained liquid source and a second end in communication with said contained liquid source,
a second wick, having a first end selectively positioned in abutment with said first end of said first wick and a second end disposed within a container, wherein a liquid contained within said contained liquid source is communicated from said first wick to said second wick when said first wick and said second wick are in abutment with each other, and wherein said first wick and said second wick are formed with a microfiber material.

11. The liquid transfer system of claim 10, further comprising:
a growing medium within said container, wherein said second end of said second wick communicates said liquid to said growing medium.

12. The liquid transfer system of claim 10 further comprising:
wherein said contained liquid source comprises a cap having an aperture defined therein, and said first wick is received through said aperture.

13. The liquid transfer system of claim 10, wherein said contained liquid source further comprises a reservoir.

14. The liquid transfer system of claim 10, wherein said container comprises an opening defined in a bottom surface of said container, and said second wick is received through said opening.
